(19) United States
(12) Patent Application Publication
(10) Pub. No.: US 2026/0185758 A1
(43) Pub. Date: Jul. 2, 2026

(54) REFRIGERANT LEAKAGE PROTECTION APPARATUS AND AIR CONDITIONING SYSTEM INCLUDING REFRIGERANT LEAKAGE PROTECTION APPARATUS

(71) Applicant: KYUNGDONG NAVIEN CO., LTD., Pyeongtaek-si (KR)

(72) Inventor: Moon Yong PARK, Seoul (KR)

(21) Appl. No.: 19/435,284

(22) Filed: Dec. 29, 2025

(30) Foreign Application Priority Data
Dec. 30, 2024 (KR) 10-2024-0199998

(51) Int. Cl. F25B 49/00

(52) U.S. Cl. CPC F25B 49/005; F25B 2500/222

(57) ABSTRACT

A refrigerant leakage may be detected to protect a system. A refrigerant leakage protection apparatus according to an example embodiment may include a sensor configured to detect refrigerant leakage of an air conditioning system and to count the number of times of correspondence to a preset concentration condition, and a relay configured to turn on or off a contact signal path of the air conditioning system according to a count result of the sensor.

### CROSS-REFERENCE TO RELATED APPLICATION(S)

This application claims benefit of priority to Korean Patent Application No. 10-2024-0199998 filed on Dec. 30, 2024, the disclosure of which is incorporated herein by reference in its entirety.

### BACKGROUND

### 1. field

The present disclosure relates to a refrigerant leakage protection apparatus and an air conditioning system including the same.

### 2. Description of Related Art

A unitary heating and cooling system according to the related art, commonly used in North America, is configured such that cooling is performed by heat transfer using an evaporator coil and a heat pump, which is an outdoor unit, to supply air to each room, and heating is performed by heat transfer using a gas air heating apparatus, or is mainly configured as an air handler in which a blower and an evaporator are integrated and a heating function may be supplemented by an electric heater. The evaporator, the gas air heating apparatus, and the air handler may be indoor air heating apparatuses disposed within a building. The gas air heating apparatus may operate by combusting gas as fuel and transferring heat generated therefrom to air. The heat pump may operate by receiving electric power and circulating refrigerant using the electric power as a driving force.

Refrigerant used in such a heating and cooling system may be flammable and thus may require leakage detection. However, a current room controller may perform only a function of controlling an indoor temperature, and thus there is a need to detect and control refrigerant leakage.

### PRIOR ART DOCUMENT

### Patent Document

Patent Document 1: Korean Patent Application Publication No. 10-2024-0102338

### SUMMARY

An aspect of the present disclosure is to provide a refrigerant leakage protection apparatus capable of detecting refrigerant leakage and protect a system, and an air conditioning system including the same.

However, the aspects of the present disclosure are not limited to those set forth herein, and other aspects set forth herein will be more easily understood by those skilled in the art from the description below.

According to an aspect of the present disclosure, there is provided a sensor unit configured to detect refrigerant leakage of an air conditioning system and to count the number of times of correspondence to a preset concentration condition, and a relay unit configured to turn on or off a contact signal path of the air conditioning system according to a count result of the sensor unit.

The sensor unit may be configured to count the number of times that a detection value of a refrigerant leakage sensor installed in a case of an A-coil of a heat exchanger of the air conditioning system corresponds to the concentration condition.

The sensor unit may be configured to update the concentration condition by expanding a range of the concentration condition when the detection value of the refrigerant leakage sensor corresponds to the concentration condition.

The sensor unit may be configured to control the relay unit to turn off the contact signal path when the number of times that the detection value of the refrigerant leakage sensor corresponds to the concentration condition meets a preset reference value.

The relay unit may be configured to turn off a contact signal path of a heat pump of the air-conditioning system according to control of the sensor unit.

According to another aspect of the present disclosure, there is provided an air conditioning system including a room controller installed indoors, the room controller configured to control indoor air conditioning, a furnace configured to heat air, a heat pump configured to heat or cool circulating refrigerant, a heat exchanger configured to exchange heat generated by the furnace and the heat pump, and a refrigerant leakage protection apparatus configured to detect refrigerant leakage of the heat exchanger and to perform a preset protection operation when a preset concentration condition is satisfied, or a room controller installed indoors, the room controller configured to control indoor air conditioning, a heat pump configured to heat or cool circulating refrigerant, an air handler configured to evaporate or condense the refrigerant, and a refrigerant leakage protection apparatus configured to detect refrigerant leakage of the air handler and to perform a preset protection operation when a preset concentration condition is satisfied.

The refrigerant leakage protection apparatus may include a sensor unit configured to sense a detection result of a refrigerant leakage sensor, configured to detect refrigerant leakage, of the air handler and to count the number of times of correspondence to the concentration condition, and a relay unit configured to turn on or off a contact signal path according to a count result of the sensor.

The sensor unit may be configured to count the number of times that a detection value of a refrigerant leakage sensor installed in a case of an A-coil of a blower of the air handler corresponds to the concentration condition.

The sensor unit may be configured to update the concentration condition by expanding a range of the concentration condition when the detection value of the refrigerant leakage sensor corresponds to the concentration condition.

The sensor unit may be configured to control the relay unit to turn off the contact signal path when the number of times that the detection value of the refrigerant leakage sensor corresponds to the concentration condition meets a preset reference value.

The relay unit may be configured to turn off a contact signal path of the heat pump according to control of the sensor unit.

According to an example embodiment of the present disclosure, refrigerant leakage may be detected in an air conditioning system, thereby protecting the air conditioning system.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic configuration diagram of an air conditioning system according to an example embodiment of the present disclosure;

FIG. 2 is a schematic configuration diagram of an air conditioning system according to another example embodiment of the present disclosure;

FIGS. 3 to 6 are examples illustrating a configuration of a refrigerant leakage protection apparatus applied to an air conditioning system and an operation according to a mode of the refrigerant leakage protection apparatus according to an example embodiment of the present disclosure; and

FIG. 7 is a flowchart illustrating an operation of a refrigerant leakage protection apparatus applied to an air conditioning system according to an example embodiment of the present disclosure.

### DETAILED DESCRIPTION

Hereinafter, example embodiments of the present disclosure will be described in detail with reference to the drawings. However, the spirit of the present disclosure is not limited to the presented example embodiments. For example, a person skilled in the art, and understanding the spirit of the present disclosure, would be able to propose other example embodiments included within the scope of the present disclosure through the addition, change, or deletion of components. All such variations are also within the scope of the present disclosure.

In addition, example embodiments of the present disclosure are provided to further describe the present disclosure to those skilled in the art.

In the drawings, shapes, sizes, and the like of elements may be exaggerated or reduced for clearer illustration.

In describing the example embodiments of the present disclosure, when it is determined that a detailed description of a known technology related to the present disclosure may unnecessarily obscure the gist of the present disclosure, the detailed description thereof will be omitted. In addition, terms to be described below are terms defined in consideration of functions in the present disclosure, which may vary depending on intention or custom of a user or operator. Therefore, the definition of these terms should be made based on the contents throughout the present specification. The terminology used herein is for the purpose of describing particular example embodiments only and is not to be limiting of the example embodiments. As used herein, the singular forms “a,” “an,” and “the” are intended to include the plural forms as well, unless the context clearly indicates otherwise.

As used herein, it should be understood that the terms “includes” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise specified in the specification of the present disclosure, “%” refers to weight %.

As used herein, terms such as “upper,” “upper portion,” “upper surface,” “lower,” “lower portion,” “lower surface,” and “side surface” are based on the drawings, may vary depending on a direction in which an element or component is actually disposed.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween.

Hereinafter, the present disclosure will be described in detail through each example embodiment or example. It should be noted that each example embodiment or example described herein is not limited to a single example embodiment or example, and combinations with other example embodiments or examples are also possible. Accordingly, citation of claims in the claims section correspond to only one example of an example embodiment, and the technical concept of the present disclosure should not be construed as being limited to combinations with the cited claims. Combinations with various claims are also within the scope of the technical concept of the present disclosure.

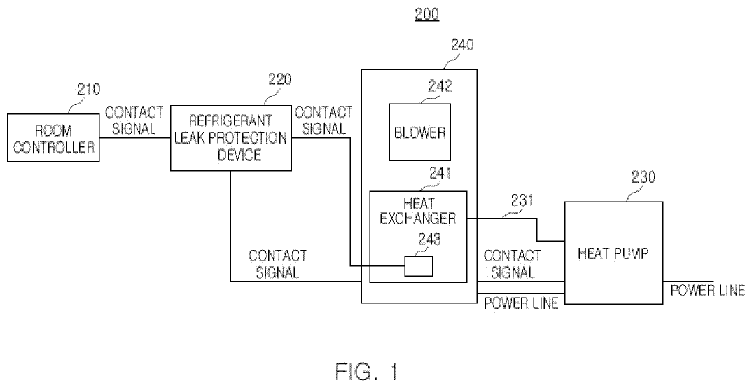

FIG. 1 is a schematic configuration diagram of an air conditioning system according to an example embodiment of the present disclosure.

Referring to FIG. 1, an air conditioning system 100 according to an example embodiment of the present disclosure may include a room controller 110, a refrigerant leakage protection apparatus 120, a heat pump 130, a heat exchange unit 140, and a furnace 150.

The room controller 110 may include a processor and a memory electrically connected to the processor, and may control indoor heating and cooling. A processor may be a component including a device capable of performing logical operations to execute a control command, and may include a central processing unit (CPU). The processor may be connected to various components to transmit a signal according to control commands to the components and perform control, and may be connected to various sensors or acquisition units to receive acquired information in the form of a signal. Accordingly, in an example embodiment of the present disclosure, the processor may be electrically connected to various components included in the air conditioning system 100. The processor may be electrically connected to the components, and thus may communicate with the components through a wired connection or through a communication module further included therein, capable of wireless communication. The control commands executed by the processor may be stored in the memory. The memory may be a storage device such as a hard disk drive (HDD), a solid-state drive (SSD), a server, a volatile medium, or a nonvolatile medium, but the type thereof is not limited thereto. The memory may further store data required by the processor to perform an operation thereof.

The refrigerant leakage protection apparatus 120 may perform a preset protection operation when a detection value of a refrigerant leakage sensor 142 installed in a heat exchanger 141 of the heat exchange unit 140 corresponds to a preset concentration condition. The concentration condition may be a concentration condition of refrigerant, and the refrigerant may be a flammable refrigerant or a mildly flammable refrigerant such as an A2L refrigerant. The protection operation may include an operation of stopping an air conditioning operation of the air conditioning system 100 when the number of times that a detection value of the refrigerant leakage sensor 142 corresponds to the concentration condition is greater than or equal to a preset reference value. The concentration condition may have a concentration range having preset upper and lower limits. When the number of times of correspondence to the concentration condition is counted, the refrigerant leakage protection apparatus 120 may expand and update the concentration range, thereby more sensitively performing detection of refrigerant leakage. The expansion of the concentration range may include updating by lowering the lower limit, raising the upper limit, or both lowering the lower limit and raising the upper limit.

The heat pump 130 may heat or cool circulating refrigerant. In an example embodiment of the present disclosure, the heat pump 130 may refer to a portion of a circuit in which the refrigerant circulates corresponding to the outdoor unit. The heat pump 130 may include a heat pump main passage 131. As the refrigerant flows through the heat pump main passage 131, the refrigerant may experience pressure changes or heat exchange. When condensation of the refrigerant occurs in the heat exchanger 141 connected to the heat pump main passage 131, heating may be performed on air. When evaporation occurs in the heat exchanger 141, cooling may be performed on air. When heating is performed, at least one of the furnace 150 and the heat pump 130 may operate for heating. When cooling is performed, only a furnace fan may operate in the furnace 150, and the heat pump 130 may operate for cooling.

The heat exchange unit 140 may include a heat exchanger 141 (A-coil or cased coil), and the heat exchanger 141 may exchange heat between refrigerant flowing in the heat pump 130 and air. The heat exchanger 141 may operate as a condenser during heating and as an evaporator during cooling. A refrigerant leakage sensor 142, detecting refrigerant leakage by sensing a concentration of refrigerant dispersed in the atmosphere, may be installed in a case of the heat exchanger 141.

The furnace 150 may include a blower 151, and may directly heat air using combustion gas or heat water circulated by combustion of fuel, and in turn heat air using the heated water.

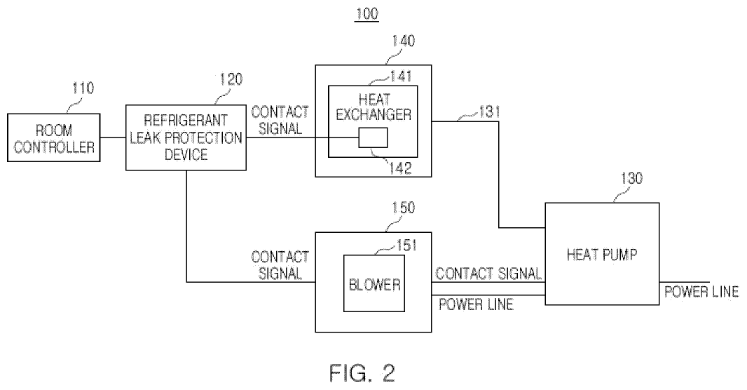

FIG. 2 is a schematic configuration diagram of an air conditioning system according to another example embodiment of the present disclosure.

Referring to FIG. 2, an air conditioning system 200 according to another example embodiment of the present disclosure may include a room controller 210, a refrigerant leakage protection apparatus 220, a heat pump 230, and an air handler 240.

The air handler 240 may include a heat exchanger 241 and a blower 242, and may exchange heat between a heat medium provided by a heat source and indoor air to heat the air and supply the heated air indoors for heating. Conversely, during cooling, the air handler 240 may exchange heat between a cooled heat medium and indoor air to cool the air and supply the cooled air indoors. A refrigerant leakage sensor 243 may be installed in a case of the heat exchanger 241 to sense a concentration of refrigerant in the atmosphere and detect refrigerant leakage. Other functions and operations of the room controller 210, the refrigerant leakage protection apparatus 220, and the heat pump 230 may be the same as or similar to the functions and operations of the room controller 110, the refrigerant leakage protection apparatus 120, and the heat pump 130 of the air conditioning system 100 according to the example embodiment illustrated in FIG. 1, and thus a detailed description thereof is omitted.

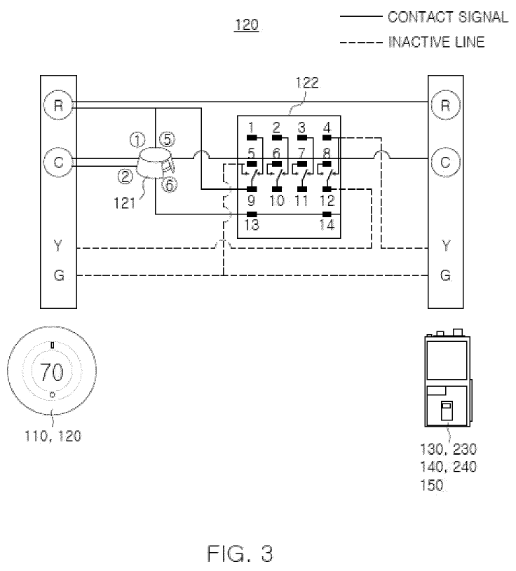

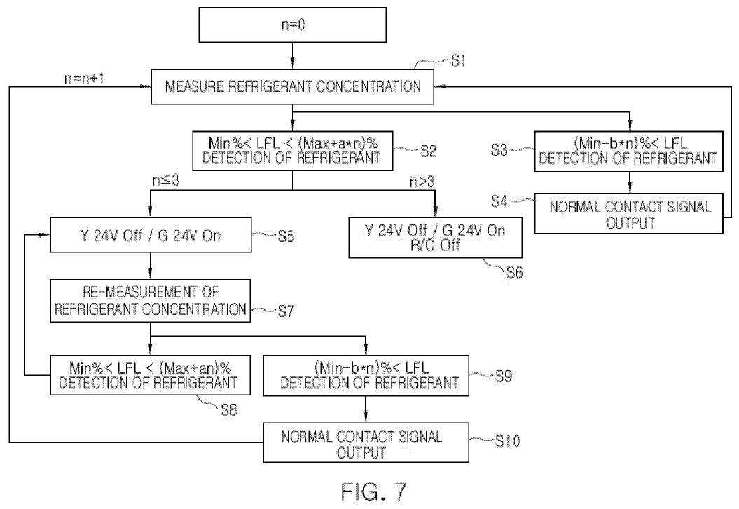

FIGS. 3 to 6 are examples illustrating a configuration of a refrigerant leakage protection apparatus applied to an air conditioning system and an operation according to a mode of the refrigerant leakage protection apparatus according to an example embodiment of the present disclosure. FIG. 7 is a flowchart illustrating an operation of a refrigerant leakage protection apparatus applied to an air conditioning system according to an example embodiment of the present disclosure.

Referring to FIGS. 3 to 6, the refrigerant leakage protection apparatus 120 may include a sensor unit 121 and a relay unit 122.

The sensor unit 121 may control a transmission path of a contact signal between the room controllers 110 and 210 and other components (the heat pumps 130 and 230, the heat exchange unit 140, the furnace 150, and the air handler 240) of the air conditioning systems 100 and 200 to be turned on or off, and the relay unit 122 may turn on or off the transmission path of the contact signal according to control of the sensor unit 121.

The contact signal may be, for example, a 24 V voltage signal, and may control an air conditioning operation by turning on or off a path of the voltage signal.

Referring to FIGS. 3 to 6, terminal R may be a 24 V contact signal terminal, terminal C may be a 0V ground terminal, terminal Y may be a contact signal terminal through which a contact signal is transmitted between the room controllers 110 and 210 and compressors of the heat pumps 130 and 230, and terminal G may be a contact signal terminal through which a contact signal is transmitted between the room controllers 110 and 210 and the blower 151 of the furnace 150 or the blower 241 of the air handler 240. The sensor unit 121 may have first to sixth pins. Among the six pins, first and second pins \textcircled{1} and \textcircled{2} may be connected to terminals R and C, respectively, a fifth pin \textcircled{3} may be connected to terminal C of the other components (the heat pumps 130 and 230, a heat exchange unit 140, the furnace 150, and the air handler 240) of the air conditioning systems 100 and 200, and the sixth pin (\textcircled{6}) may be connected to a thirteenth pin relay and a fourteenth pin relay of the relay unit 122. Although not illustrated, a third pin and a fourth pin of the sensor unit may be connected to a refrigerant leakage sensor to count the number of times of correspondence to the concentration condition. The relay unit 122 may be a 14-pin relay. A fourth pin relay may be connected to terminal Y of the compressors of the heat pumps 130 and 230, a fifth pin relay may be connected to terminal G of the blower 151 of the furnace 150 or the blower 241 of the air handler 240 and the room controllers 110 and 210, and a twelfth pin relay may be connected to terminal Y of the room controllers 110 and 210.

Referring to FIGS. 3 and 7, when the air conditioning systems 100 and 200 are in a non-operation state, the refrigerant leakage protection apparatus 120 may measure a concentration of refrigerant (S1). When no refrigerant leakage is detected (S3) or when the number of times of correspondence to the concentration condition is less than or equal to a reference value, terminals R and C may be connected to a path of a 24 V contact signal (S4), and terminals Y and G may be in an inactive line state.

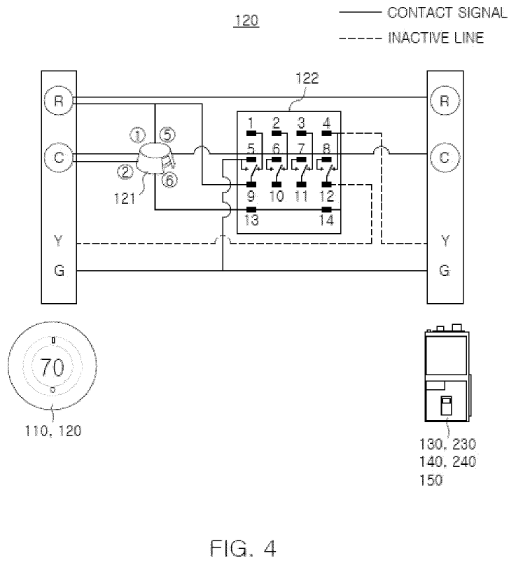

Referring to FIG. 4, when the air conditioning systems 100 and 200 is in a non-operation state, the refrigerant leakage protection apparatus 120 may measure a concentration of refrigerant (S1). When the number of times of correspondence to the concentration condition (S2) meets a reference value, terminal Y of the room controllers 110 and 210 and the compressors of the heat pumps 130 and 230 and terminal G of the room controllers 110 and 210 may be set to an inactive line state, and a contact signal of terminal G connected to the blower 151 of the furnace 150 or the blower 241 of the air handler 240 may be set to an active state to dilute a concentration of leaked refrigerant (S6).

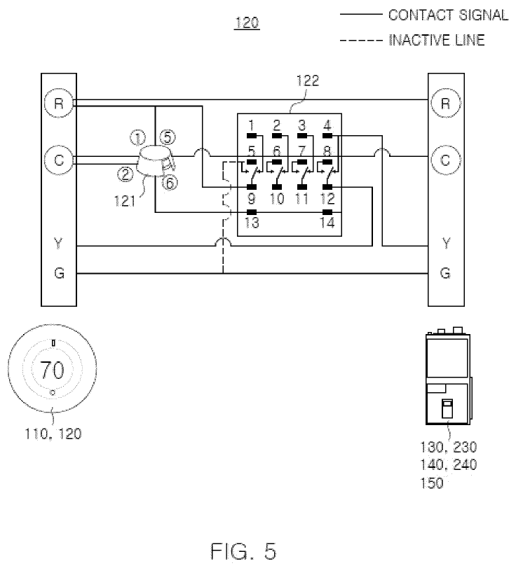

Referring to FIG. 5, when the air conditioning systems 100 and 200 are in an operation state, the refrigerant leakage protection apparatus 120 may measure a concentration of refrigerant (S1). When no refrigerant leakage is detected (S3) or when the number of times of correspondence to the concentration condition (S2) is less than or equal to a reference value, terminals R, C, Y, and G may be connected to a path of a 24 V contact signal (S4 and S10).

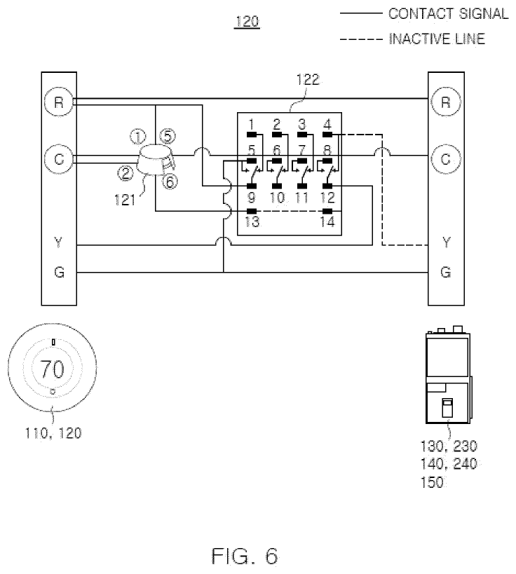

Referring to FIG. 6, when the air conditioning systems 100 and 200 are in an operation state, the refrigerant leakage protection apparatus 120 may measure a concentration of refrigerant (S1). When the number of times of correspondence to the concentration condition (S2) meets a reference value, terminal Y of the compressors of the heat pumps 130 and 230 may be set to an inactive line state to stop an air conditioning operation, and terminals Y and G of the room controllers 110 and 210 and terminal G connected to the blower 151 of the furnace 150 or the blower 241 of the air handler 240 may be set to an active state (S6) to dilute a concentration of leaked refrigerant.

The concentration condition may have a concentration range having a preset upper limit (Max %) and lower limit (Min %). When the number of times (n) corresponding to the concentration condition is counted, the refrigerant leakage protection apparatus 120 may expand and update the concentration range, thereby more sensitively performing detection of refrigerant leakage. The expansion of the concentration range may include updating by lowering the lower limit ((Min−b*n)%) (S9), raising the upper limit ((Max+a*n)%) (S8), or both lowering the lower limit and raising the upper limit during re-measurement of the refrigerant concentration (S7).

In the related art, when leakage is stopped, contact Y may be disconnected to stop a compressor, and a 24 V contact signal may be supplied to contact G to operate a blower. A system may perform sensing at predetermined intervals. When no refrigerant is detected, the system may return to a normal state. When refrigerant leakage occurs while the blower operates, a refrigerant concentration may decrease, and the system may return to a normal state. After a certain period of time, the refrigerant concentration may increase again. Until all refrigerant is leaked, operation and stoppage of the blower may be repeated, making it difficult for a user to recognize whether refrigerant leakage occurs. Conversely, according to the present disclosure, when leakage is stopped, contact Y may be disconnected to stop a compressor, and a 24 V contact signal may be supplied to contact G to operate a blower. A system may perform sensing at predetermined intervals. When no refrigerant is detected, the system may return to a normal state. The number of times of leakage may be counted. Based on the number of times of leakage, an upper limit of a refrigerant detection reference may be lowered and a lower limit of a non-detection reference may be raised. For example, when upon accumulation of three or more leakage events, a 24 V contact signal of terminals R/C may be disconnected to cut off power to a thermostat (room controller function). For example, the counted number of times of leakage may be reset at intervals of 24 hours. As described above, refrigerant leakage may be sensitively detected based on the counted number of times of refrigerant leakage and a history of refrigerant leakage. A limit for the number of times of leakage may be set. When leakage is repeatedly detected within a certain period, power to the thermostat may be cut off, such that a user may recognize an abnormal condition during normal use.

As described above, according to the present disclosure, in an air conditioning system, refrigerant leakage may be detected with a simple configuration, thereby protecting the air conditioning system.

While example embodiments have been shown and described above, it will be apparent to those skilled in the art that modifications and variations could be made without departing from the scope of the present disclosure as defined by the appended claims.

What is claimed is:

1. A refrigerant leakage protection apparatus comprising:
a sensor configured to detect refrigerant leakage of an air conditioning system and to count the number of times corresponding to a preset concentration condition; and
a relay configured to turn on or off a contact signal path of the air conditioning system according to a count result of the sensor.

2. The refrigerant leakage protection apparatus of claim 1, wherein the sensor is configured to count the number of times that a detection value of a refrigerant leakage sensor installed in a case of a heat exchanger of the air conditioning system corresponds to the concentration condition.

3. The refrigerant leakage protection apparatus of claim 2, wherein the sensor is configured to update the concentration condition by expanding a range of the concentration condition when the detection value of the refrigerant leakage sensor corresponds to the concentration condition.

4. The refrigerant leakage protection apparatus of claim 2, wherein the sensor is configured to control the relay to turn off the contact signal path when the number of times that the detection value of the refrigerant leakage sensor corresponds to the concentration condition meets a preset reference value.

5. The refrigerant leakage protection apparatus of claim 4, wherein the relay is configured to turn off a contact signal path of a heat pump of the air conditioning system according to control of the sensor.

6. An air conditioning system comprising:
a room controller installed indoors, the room controller configured to control indoor air conditioning;
a furnace configured to heat air;
a heat pump configured to heat or cool circulating refrigerant;
a heat exchanger configured to exchange heat generated by the furnace and the heat pump; and
a refrigerant leakage protection apparatus configured to detect refrigerant leakage of the heat exchanger and to perform a preset protection operation when a preset concentration condition is satisfied.

7. The air conditioning system of claim 6, wherein the refrigerant leakage protection apparatus includes:
a sensor configured to sense a detection result of a refrigerant leakage sensor of the heat exchanger and to count the number of times of correspondence to the concentration condition; and
a relay configured to turn on or off a contact signal path according to a count result of the sensor.

8. The air conditioning system of claim 7, wherein the sensor is configured to count the number of times that a detection value of a refrigerant leakage sensor installed in a case of the heat exchanger corresponds to the concentration condition.

9. The air conditioning system of claim 8, wherein the sensor is configured to update the concentration condition by expanding a range of the concentration condition when a detection value of the refrigerant leakage sensor corresponds to the concentration condition.

10. The air conditioning system of claim 8, wherein the sensor is configured to control the relay to turn off the contact signal path when the number of times that the detection value of the refrigerant leakage sensor corresponds to the concentration condition meets a preset reference value.

11. The air conditioning system of claim 10, wherein the relay is configured to turn off a contact signal path of the heat pump according to control of the sensor.

12. An air conditioning system comprising:
a room controller installed indoors, the room controller configured to control indoor air conditioning;
a heat pump configured to heat or cool circulating refrigerant;
an air handler configured to evaporate or condense the refrigerant; and
a refrigerant leakage protection apparatus configured to detect refrigerant leakage of the air handler and to perform a preset protection operation when a preset concentration condition is satisfied.

13. The air conditioning system of claim 12, wherein the refrigerant leakage protection apparatus includes:
a sensor configured to sense a detection result of a refrigerant leakage sensor of the air handler and to count the number of times of correspondence to the concentration condition; and
a relay configured to turn on or off a contact signal path according to a count result of the sensor.

14. The air conditioning system of claim 13, wherein the sensor is configured to count the number of times that a detection value of a refrigerant leakage sensor installed in a case of a heat exchanger of the air handler corresponds to the concentration condition.

15. The air conditioning system of claim 14, wherein the sensor is configured to update the concentration condition by expanding a range of the concentration condition when a detection value of the refrigerant leakage sensor corresponds to the concentration condition.

16. The air conditioning system of claim 14, wherein the sensor is configured to control the relay to turn off the contact signal path when the number of times that the detection value of the refrigerant leakage sensor corresponds to the concentration condition meets a preset reference value.

17. The air conditioning system of claim 16, wherein the relay is configured to turn off a contact signal path of the heat pump according to control of the sensor.
